(19) United States
(12) Patent Application Publication
(10) Pub. No.: US 2014/0355116 A1
(43) Pub. Date: Dec. 4, 2014

(54) Polarizer for Dimming Device

(71) Applicant: Benq Materials Corporation, Guishan Township (TW)

(72) Inventors: Lung-Hai Wu, Taoyuan City (TW); Cyun-Tai Hong, New Taipei City (TW); Chun-Nan Shen, Luzhu Township (TW); Meng-Chieh Wu, New Taipei City (TW)

(73) Assignee: Benq Materials Corporation, Guishan Township (TW)

(21) Appl. No.: 14/290,561

(22) Filed: May 29, 2014

(30) Foreign Application Priority Data
May 30, 2013 (TW) 102119104

(51) Int. Cl. G02B 5/30

(52) U.S. Cl. CPC G02B 5/3083
USPC 359/489.07

(57) ABSTRACT

A polarizer for a dimming device. The polarizer includes a polarization layer with an absorption axis; and a patterned retarder layer on the polarization layer and comprising patterned alignment microstructures and a liquid crystal layer disposed on the patterned alignment microstructures, wherein the patterned alignment microstructures are formed by embossing and the optical axis of the patterned retarder layer is continuous.

### CROSS-REFERENCE TO RELATED APPLICATION

This application claims the benefit of Taiwan Patent Application No. 102119104, filed on May 30, 2013, in the Taiwan Intellectual Property Office, the disclosure of which is incorporated herein in its entirety by reference.

### BACKGROUND

1. Technical Field

The present invention relates to a polarizer for using in a dimming device. In particular, the present invention relates to a polarizer which can polarize light into various polarization directions.

2. Description of Related Art

In view of the demanding on aesthetics and functions for large windows, the requirements for different types of smart windows and window shades are increased. Currently, a smart window with adjustable light transmission has been on the market, which comprises two polarizers together with two patterned retarders disposed therebetween. The patterned retarder in the current smart windows is composed of areas of various optical axes to make the light transmitted thereto to be polarized into various polarization directions. Thus, the light transmission of the current smart window can be controlled by adjusting the alignment of the two retarders together with the two polarizers. At present, the retarder composed of areas of various optical axes is manufactured by photolithography process with photo-masks of specific defined pattern via multiple exposure treatments to form a retarder with alignment microstructures. However, the photo-etched alignment microstructure formed in the current photolithography process is in a form of a straight line, all the pattern are configured with straight lines which cannot be smooth and continuous, such as curves. The manufacturing process used in prior art for making the patterned retarder is complicated and difficult and the patterned retarder obtained thereby cannot provide an optical axis resulted from the alignment microstructure to be consecutively shifted in various polarization directions.

The inventors of the present invention provide a polarizer using in dimming devices, which is patterned with a variously continuous optical axes for adjusting the transmission of light. The present polarizer is manufactured by embossing process which is used for manufacturing retarders used in stereographic displays.

### SUMMARY OF THE INVENTION

Accordingly, the present disclosure is to provide a novel, inventive and useful polarizer for using in a dimming device.

An aspect of the present disclosure is to provide a polarizer for using in a dimming device. In a preferred embodiment of the present invention, the polarizer comprises a polarization layer with an absorption axis; and a patterned retarder layer disposed on the polarization layer and comprising patterned alignment microstructures and a liquid crystal layer disposed on the patterned alignment microstructures, wherein the patterned alignment microstructures are formed by embossing and the optical axes of the patterned retarder layer are consecutively shifted in various polarization directions.

In a polarizer of a preferred embodiment of the present invention, the patterned alignment microstructures are formed by embossing with an engraving roller or a mold.

In a polarizer of a preferred embodiment of the present invention, the optical axes of the patterned retarder layer are arranged in one of the forms of curves, polylines, straight lines and a combination thereof.

In a polarizer of a preferred embodiment of the present invention, retardation values of the patterned retarder layer are ±λ/4 and directions of the optical axes of the patterned retarder layer are in an angle of +45 degrees or −45 degrees to a direction of the absorption axis of the polarization layer. In another preferred embodiment of the present invention, the retardation values of the patterned retarder layer are ±λ/2.

In a polarizer of a preferred embodiment of the present invention, the polarization layer is selected from the group consisting of an absorption-type polarizer, a reflective polarizer, a dyeing polarizer, a coatable polarizer, a wire grid polarizer and a combination thereof.

In a polarizer of a preferred embodiment of the present invention, the polarizer of the present invention further comprises a protective layer on an opposite side to the polarization layer with respect to the patterned retarder layer. The protective layer is selected from the group consisting of glass, triacetate cellulose film, polyester film and cyclo-olefin film. In another preferred embodiment of the present invention, the protective layer is a functional layer selected from the group consisting of a thermal insulation layer, an antiknock layer, a hard coating layer, an antifouling layer, a brightness enhancement layer and a combination thereof.

In a polarizer of a preferred embodiment of the present invention, the patterned alignment microstructures of the patterned retarder layer are configured to vary in a continuous optical axis and a discontinuous optical axis.

### BRIEF DESCRIPTION OF THE DRAWINGS

The accompanying drawings, which are incorporated herein and constitute part of this specification, illustrate example embodiments of the invention, and together with the general description given above and the detailed description given below, serve to explain the features of the invention.

FIG. 1 is a diagram illustrating a polarizer known in the prior art for using in a dimming device;

FIGS. 2a to 2c are diagrams illustrating the change of the optical axes in a polarizer used in a dimming device known in the prior art;

FIG. 3 is a perspective view illustrating a polarizer for using dimming device of a preferred embodiment of the present invention;

FIGS. 4a to 4c diagrams illustrating the change of the optical axes in a polarizer used in a dimming device of a preferred embodiment of the present invention;

FIG. 5 shows the difference of the optical axes between the polarizer of a preferred embodiment of the present invention and that of a polarizer with similar pattern known in the prior art;

FIG. 6 shows the difference of the optical axes between the polarizer of another preferred embodiment of the present invention and that of a polarizer with similar pattern known in the prior art;

FIG. 7 shows a perspective view of a retarder used in a polarizer of a preferred embodiment of the present invention for using in a dimming device;

FIG. 8 shows a perspective view of a retarder used in a polarizer of another preferred embodiment of the present invention for using in a dimming device; and

FIG. 9 shows a perspective view of a polarizer of another preferred embodiment of the present invention for using in a dimming device.

### DESCRIPTION OF EMBODIMENTS OF THE INVENTION

To describe the technical features of the present invention in greater detail, preferred embodiments of the present invention are provided below along with the accompanied drawings accordingly as follows. The various embodiments will be described in detail with reference to the accompanying drawings. References made to particular examples and implementations are for illustrative purposes, and are not intended to limit the scope of the invention or the claims.

The dimming device of the present invention will be described along with the accompanied drawings accordingly as follows. It is appreciated that the same reference numbers will be used throughout the drawings to refer to the same or like parts.

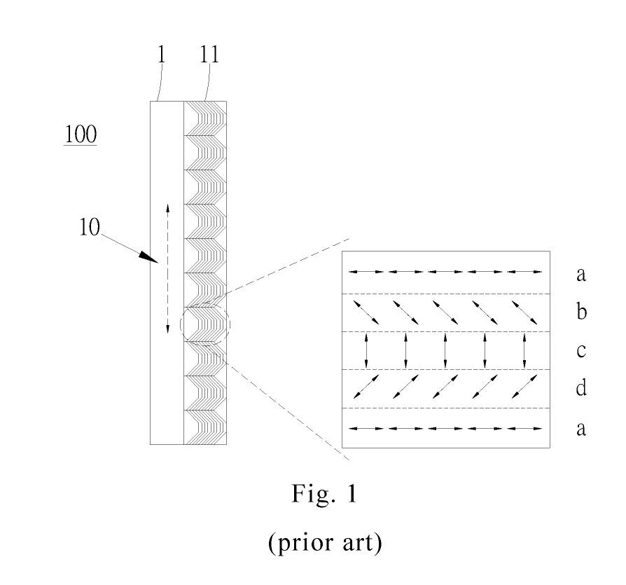

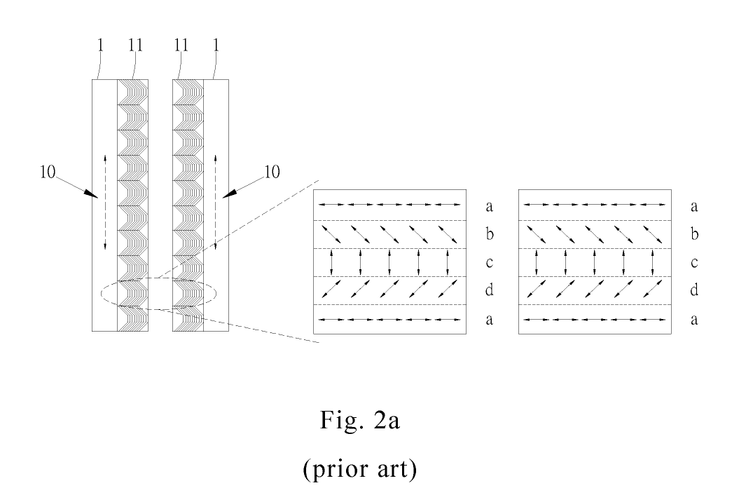

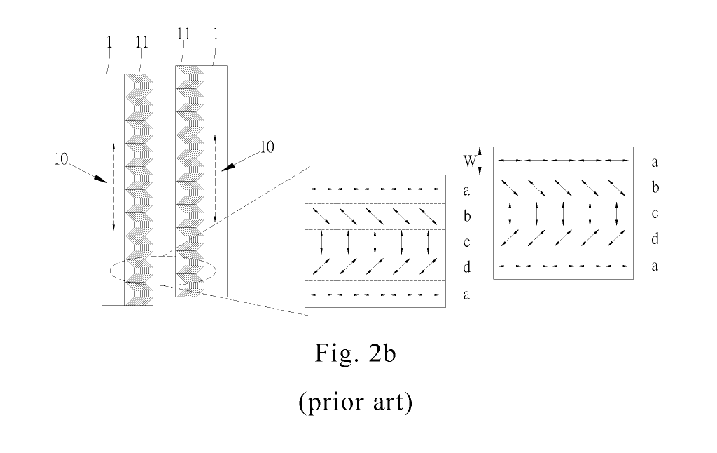

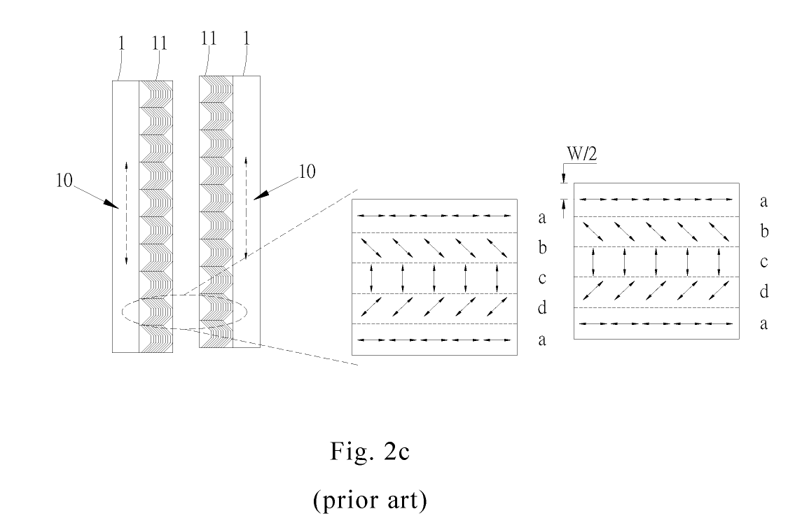

FIG. 1 is a diagram illustrating a polarizer 100 known in the prior art for using in a dimming device. The polarizer 100 comprises a polarization layer 1 with an absorption axis 10 and a patterned retarder 11 disposed on one side of the polarization layer 1. The patterned retarder comprises a patterned alignment microstructure which is manufactured by conventional photolithographic process known to the skilled artisan in the related art. The patterned alignment microstructure comprises consecutive subareas a, b, c and d of patterned alignment microstructures arranged in different directions as shown in FIG. 1. After coating and curing a layer of liquid crystal on the patterned alignment microstructure, the optical axes of the subareas a, b, c, and d are thus in different directions, respectively. Referring to FIGS. 2a, 2b and 2c, a dimming device is assembled by two polarizers 100, wherein the retardation values of the patterned retarder layer is ±λ/2. As in FIG. 2a, the two polarizers are completely overlapped and the optical axes of the subareas a, b, c and d in one polarizer are correspondingly parallel to those of the other one polarizer. In this case, the light fully transmits through the dimming device. As shown in FIG. 2b, when one of the polarizers is moved a distance of the width (w) of a subarea to make the consecutive subareas a, b, c and d in one polarizer is overlapped on the consecutive subareas b, c, d and a in the other polarizer. It makes that the optical axes of the consecutive subareas a, b, c and d in one polarizer is at angle of 45 degree to those of the consecutive subareas b, c, d and a in the other polarizer. In this case, the light cannot transmit through the dimming device. Referring to FIG. 2c, when one of the polarizers is moved a distance of half of the width (w/2) of a subarea to make the consecutive subareas a, b, c and d in one polarizer is not aligned to the correspondingly consecutive subareas a, b, c, and d in the other polarizer. It makes that the optical axes of the consecutive subareas a, b, c and d in one polarizer is partly parallel to or partly at angle of 45 degree to those of the consecutive subareas a, b, c, and d in the other polarizer. In this case, the dimming device is in a semi-light-transmission state comprising part of full-light transmission and part of dark state. For achieving a more homogenous semi-light-transmission state, one solution provided in the prior art is to decrease the pitch of the subareas of the patterned retarder 11 by decreasing the line pitches of the photo-mask used in photolithographic process. The decrease of the pitch of the subareas in the patterned retarder will enable the optical axes of the subareas to be connected to a smoother and continuous solid curve line. However, the solution provided in the prior art will increase the complication of the manufacture process of the patterned retarder 11. Even decreasing the pitch of the subareas in the patterned retarder, a homogenously transitional state is still unable to be obtained as expected.

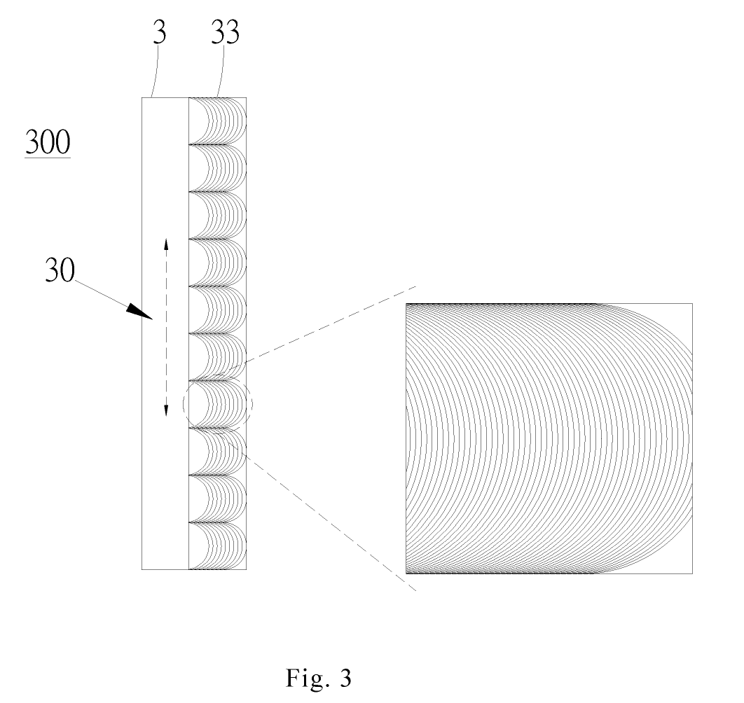

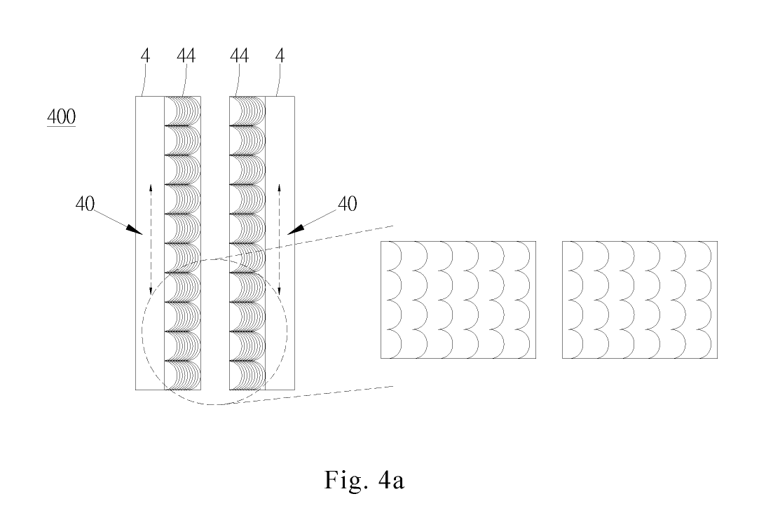

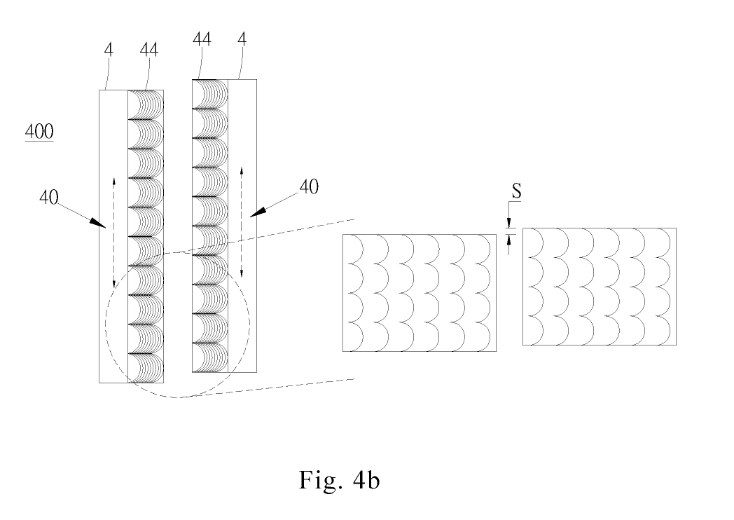

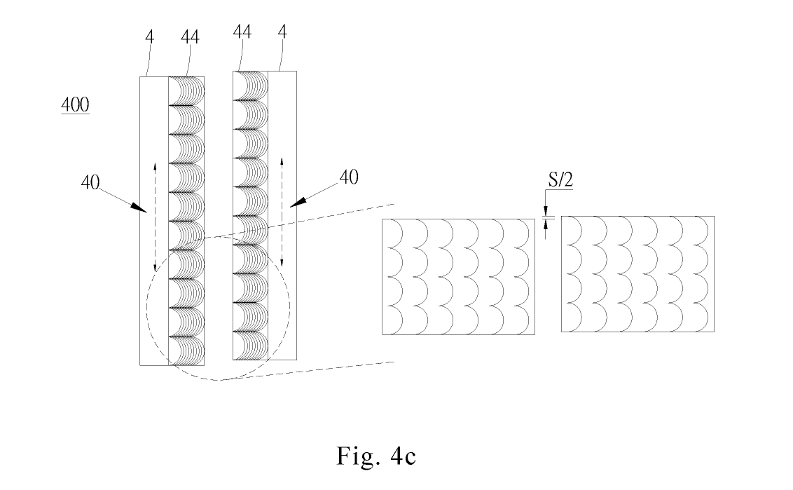

FIG. 3 shows a polarizer 300 for using in a dimming device of a preferred embodiment of the present invention. The polarizer 300 comprises a polarization layer 3 with an absorption axis 30 and a patterned retarder 33 disposed on one side of the polarization layer 3. The patterned retarder 33 comprises patterned alignment microstructures and a layer of liquid crystal disposed thereon. After thermal curing or UV curing the liquid crystal layer, the patterned retarder 33 generates a retardation value. In this embodiment of the present invention, the pattern of the patterned alignment microstructures is formed by embossing process in order to obtain a pattern of continuous optical axis varied in directions, such as a curved line. The pattern of the patterned alignment microstructures can further comprise a pattern of optical axis varied in directions, such as a polyline. As shown in FIGS. 4a to 4c, the polarizer 400 of the present invention used in a dimming device comprises a polarization layer 4 and a patterned retarder 44. In this embodiment, a dimming device is assembled by two polarizers 400, wherein the retardation values of the patterned retarder 44 are ±λ/2. As in FIG. 4a, the two polarizers are completely overlapped, the optical axes in one polarizer are correspondingly parallel to those of the other one polarizer. In this case, the light fully transmits through the dimming device. As shown in FIG. 4b, when one of the polarizers is moved a distance (S) to enable the optical axes of one polarizer overlapped all being at angle of 45 degree to those of the other polarizer. In this case, the light cannot transmit through the dimming device. When one of the polarizers is moved a distance between 0 to S, such as S/2, to enable the optical axes of one polarizer being at an angle between 0 to 45 degrees to the optical axes of another one polarizer, as shown in FIG. 4c. In this case, the dimming device is in a homogenously semi-light-transmission state.

In a polarizer of the preferred embodiment of the present invention, the patterned alignment microstructures of the patterned retarder layer can be manufactured by, such as, embossing method with an engraving roller or a molded stamp. The embossing method for manufacturing a patterned retarder layer comprises engraving the surface of a roller for the patterned alignment microstructures, embossing a film with the engraving roller for forming the patterned alignment microstructures on the film.

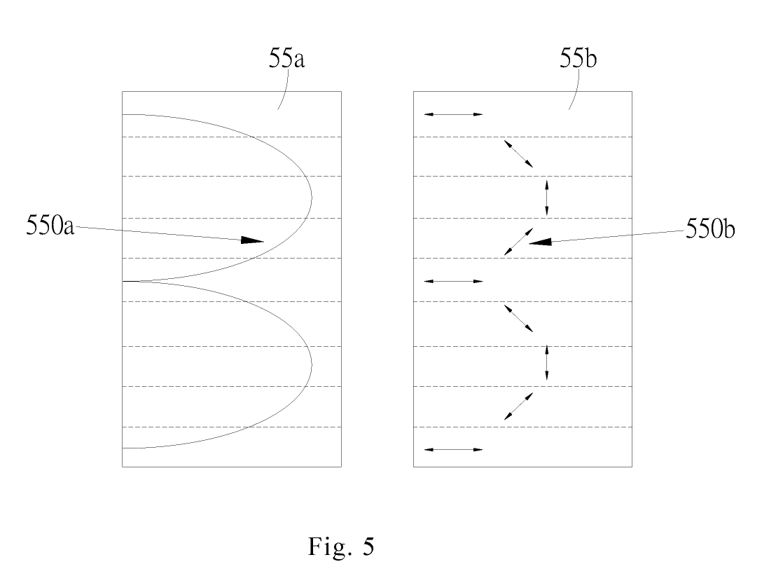

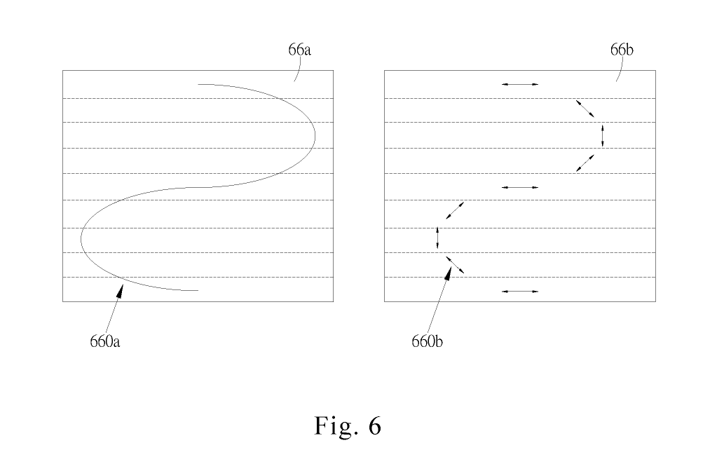

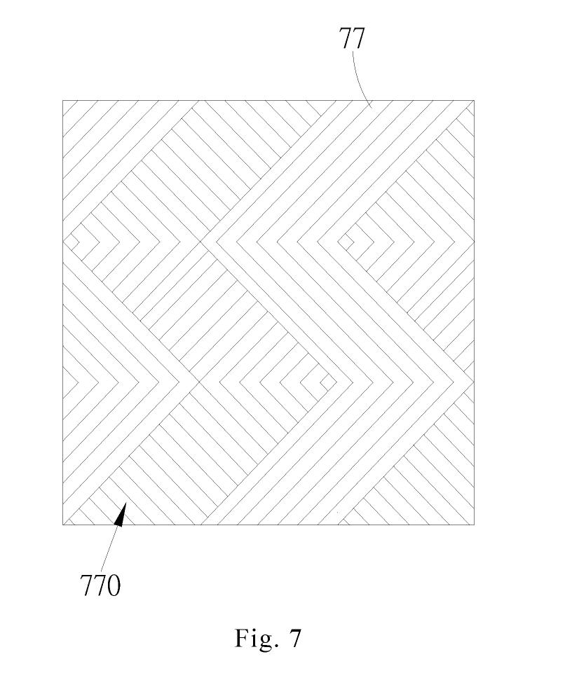

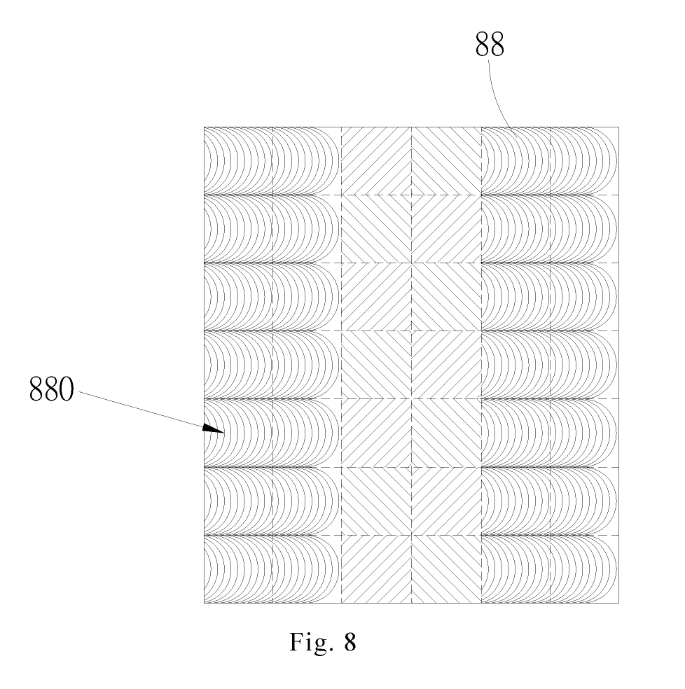

In a polarizer of the preferred embodiment of the present invention, the optical axes of the patterned retarder layer are arranged in one of the forms of curves, polylines, straight lines and a combination thereof. FIGS. 5 and 6 show the comparisons of the retarder layers of the present invention and the retarder layers of prior art. FIG. 5 shows a perspective view of the patterned alignment microstructures in patterned retarder layers 55a of a preferred embodiment of the present invention which exhibits a continuous curved optical axis 550a with various optical directions. FIG. 6 shows a perspective view of patterned alignment microstructures in patterned retarder layers 66a of another preferred embodiment of the present invention which exhibits a continuous curved optical axis 660a with various optical directions. Both of the patterned retarder layers 55a and 66a of the present invention are manufactured by embossing a film with an engraving roller to form the patterned alignment microstructures thereon. FIGS. 5 and 6 also show patterned retarder films 55b and 66b of prior art, which are manufactured by photolithography process via multiple exposure treatments. The optical axes 550b of the patterned retarder film 55b and the optical axes 660b of the patterned retarder film 66b can be solely in broken-line because only microstructure in straight line can be formed in the photolithography process. Further referring to FIG. 7, it shows a polarizer of a preferred embodiment of the present invention, which comprises a patterned retarder layer 77 with patterned alignment microstructures manufactured by embossing process. The patterned alignment microstructures in the patterned retarder layer 77 composed of a plurality of sets of continuous polylines and a plurality of straight lines interposing the sets of polylines. Although the optical axes 770 of the retarder layer 77 comprise a variety of turning points, the patterned alignment microstructures can be manufactured by embossing process to be formed in various optical directions, rather than by multiple exposure treatment in photolithography process. Thus, the present invention can provide a polarizer with a variety of designs of pattern for a dimming device. Furthermore, the present polarizer can be manufactured by a less complicated manufacture process. FIG. 8 shows a polarizer of another one preferred embodiment of the present invention. The microstructure of the patterned retarder layer 88 is manufactured by embossing process with an engraving roller. The optical axes 880 of the patterned retarder layer 88 compose of a plurality of curved lines and a plurality of polylines in various directions. In a dimming device assembled by two sets of the polarizers 88 in overlapped form, when the overlapped polarizers are relatively moved in opposition directions for a distance, the dimming device will exhibit a combination of full-light transmission state, a semi-full-light transmission state, dark state, and a transitional state composed with full light transmission state and dark state.

In a preferred embodiment of the present invention, the retardation value of the patterned retarder layer of the polarizer is ±λ/4 and the directions of the optical axes of the patterned retarder layer are in an angle of +45 degrees or −45 degrees to the direction of the absorption axis of the polarization layer. Therefore, the light transmitted into the present polarizer will be polarized into circularly polarized light. In another preferred embodiment of the present invention, the retardation value of the patterned retarder layer of the polarizer is ±λ/2, the light transmitted into the present polarizer will thus be polarized into linear polarized light in a different polarization direction. When using two sets of the present polarizers in a dimming device, the absorption axes of the polarization layers of the polarizers can be parallel to or perpendicular to each other in dependent to the retardation values of the patterned retarder layer.

In a polarizer of another one embodiment of the present invention, the polarization layer can be absorption-type polarization layer or reflective polarization layer. In an embodiment that the polarizer of the present invention using an absorption-type polarization layer is assembled in a dimming device, when the dimming device is light un-transmissible, the light transmitted therethrough is absorbed by the absorption-type polarization layer and the dimming device exhibits a dark state. In another embodiment that the polarizer of the present invention using an reflective-type polarization layer is assembled in a dimming device, when the dimming device is light un-transmissible, the light transmitted therethrough is reflected by the reflective-type polarization layer and the dimming device exhibits a mirror function. Furthermore, the first polarizer and the second polarizer can be dyeing type polarizers, coatable polarizers, wire grid polarizers and a combination thereof.

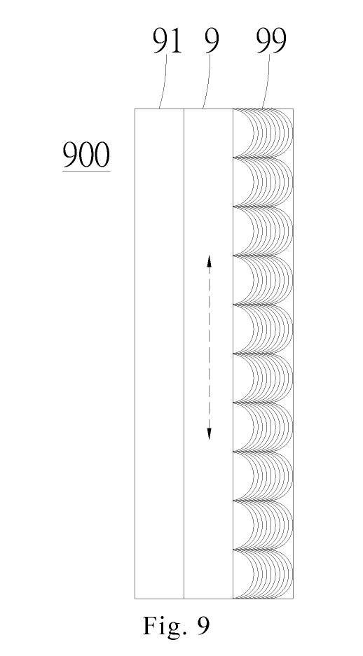

FIG. 9 shows a polarizer 900 of still another one preferred embodiment of the present invention. The polarizer 900 comprises a protective layer 91 on one side of the polarization layer 9 opposite to the side of the patterned retarder 99 for protecting the polarization layer 9. The protective layer 91 is selected from the group consisting of glass, triacetate cellulose film, polyester film and cyclo-olefin film. In a polarizer of another embodiment of the present invention, the protective layer 91 is a functional layer selected from the group consisting of a thermal insulation layer, an antiknock layer, a hard coating layer, an antifouling layer, a brightness enhancement layer and a combination thereof.

The foregoing description of the exemplary embodiments of the invention has been presented only for the purposes of illustration and description and is not intended to be exhaustive or to limit the invention to the precise forms disclosed. Many modifications and variations are possible in light of the above teaching.

The embodiments were chosen and described in order to explain the principles of the invention and their practical application so as to activate others skilled in the art to utilize the invention and various embodiments and with various modifications as are suited to the particular use contemplated. Alternative embodiments will become apparent to those skilled in the art to which the present invention pertains without departing from its spirit and scope. Accordingly, the scope of the present invention is defined by the appended claims rather than the foregoing description and the exemplary embodiments described therein.

What is claimed is:

1. A polarizer for a dimming device comprising:
a polarization layer with an absorption axis; and
a patterned retarder layer disposed on the polarization layer and comprising patterned alignment microstructures and a liquid crystal layer disposed on the patterned alignment microstructures;
wherein the patterned alignment microstructures are formed by embossing process and directions of optical axes of the patterned retarder layer continuously varies.

2. The polarizer of claim 1, wherein the patterned alignment microstructures are formed by embossing with an engraving roller or a mold.

3. The polarizer of claim 1, wherein the optical axes of the patterned alignment microstructure are arranged in one of the forms of curves, polylines, straight lines or a combination thereof.

4. The polarizer of claim 1, wherein retardation values of the patterned retarder layer are ±λ/4 and the directions of the optical axes of the patterned retarder layer are in an angle of +45 degrees or −45 degrees to a direction of the absorption axis of the polarization layer.

5. The polarizer of claim 1, wherein retardation values of the patterned retarder layer are ±λ/2.

6. The polarizer of claim 1, wherein the polarization layer is selected from the group consisting of an absorption-type polarizer, a reflective polarizer, a dyeing polarizer, a coatable polarizer, a wire grid polarizer and a combination thereof.

7. The polarizer of claim 1, further comprising a protective layer on an opposite side to the polarization layer with respect to the patterned retarder layer.

8. The polarizer of claim 7, wherein the protective layer is selected from the group consisting of glass, triacetate cellulose film, polyester film and cyclo-olefin film.

9. The polarizer of claim 7, wherein the protective layer is a functional layer selected from the group consisting of a thermal insulation layer, an antiknock layer, a hard coating layer, an antifouling layer, a brightness enhancement layer and a combination thereof.

10. The polarizer of claim 1, wherein the patterned alignment microstructures of the patterned retarder layer are configured to vary in a continuous optical axis and a discontinuous optical axis.
